(19) United States
(12) Patent Application Publication
(10) Pub. No.: US 2004/0200152 A1
(43) Pub. Date: Oct. 14, 2004

(54) Modular composite sill for threshold

(76) Inventor: Haik Khanlarian, Memphis, TN (US)

Correspondence Address: HUSCH & EPPENBERGER, LLC, 190 CARONDELET PLAZA, SUITE 600, ST. LOUIS, MO, 63105-3441, US

(21) Appl. No.: 10/411,535

(22) Filed: Apr. 10, 2003

(51) Int. Cl. E06B 1/70

(52) U.S. Cl. 49/468

(57) ABSTRACT

An adjustable sill assembly includes an elongated substrate base composed of a molded composite material and defining a T-shaped slot extending along the length of the substrate base and open to a top surface of the substrate base; a sill plate connected with the substrate base; a riser having a top and two downwardly-extending legs defining an interior of the riser, the interior of the riser having a pair of flanges angling downward and toward one another; and means for connecting the substrate base with the riser including a T-nut having a flange and a corresponding screw, the T-nut being slidebly and non-rotatably supported within the T-shaped slot and the screw being rotatably and slideably supported by the pair of flanges and wherein the riser is secured to the substrate base by inserting the screw into the T-nut.

### TECHNICAL FIELD OF THE INVENTION

The present invention relates generally to door frames and, more particularly, to a modular sill assembly which may be vertically adjusted and adapted for a variety of doorway configurations.

### BACKGROUND OF THE INVENTION

In a standard threshold assembly, a sloping sill is attached to a base. The sill is oriented on the exterior of the door frame. A trim piece or nosing is generally attached to the opposite side of the base facing the interior of the door frame. Between the sill and trim piece, a riser or threshold cap is attached to the top of the base. The riser is positioned to underlie the door when it is in a closed position and form a seal with the bottom of the door.

Several methods of attaching the riser to the base exist in the prior art. In particular, a number of these prior art designs provide for adjustment in the height of the riser relative to the base. These prior art designs tend to incorporate mechanisms, for example, corresponding nut and screw assemblies, that are fixed in position relative to the length of the base.

The manufacture of the individual pieces comprising a sill assembly and the method of attaching the riser to the base have presented numerous design issues to the millwork industry. One particularly troublesome issue is the fact that, doorways, come in a large variety of configurations. For instance, a door frame may accommodate a door and a non-moving sidelight or a pair of opposing (“french”) doors and an astragal which may or may not be attached to one of the opposing doors. Current sill designs can be used in a limited number of configurations and provide little flexibility in the available configurations. While manufacturers have attempted to design threshold assemblies that are adaptive in some aspects, none have produced a design that provides sufficient adaptability. As mentioned above, the prior art designs generally utilize attachment mechanisms that are fixed in position relative to the length of the base.

Furthermore, these prior art designs utilize a large amount of custom hardware, particularly in their attachment mechanisms, such as specialized shoulder screws and push nuts. This custom hardware increases the cost of the sill assembly and requires that manufacturers stock a large amount of custom pieces for which they have no other use.

An improved sill assembly would preferably have a modular design that is capable of ready adaptation to various doorway configurations, while requiring a minimal amount of custom hardware for assembly.

The present invention is directed to overcoming one or more of the problems set forth above.

### SUMMARY OF THE INVENTION

An aspect of the present invention is to provide a modular sill assembly that is easily adapted to a variety of different doorway configurations.

Another aspect of the present invention is to provide a modular sill assembly that utilizes a means of connecting a riser to a substrate that is easily adaptable to whatever length and arrangement is required by a particular doorway design.

Yet another aspect of the present invention is to provide a modular sill assembly that utilizes a minimal number of custom parts for assembly, thereby enhancing interchangability of parts in the system.

In accordance with the above aspects of the invention, there is provided an adjustable threshold assembly that includes an elongated substrate base composed of a molded composite material and defining a T-shaped slot extending along the length of the substrate base and open to a top surface of the substrate base; a sill plate connected with the substrate base; a riser having a top and two downwardly-extending legs defining an interior of the riser, said interior of the riser having a pair of flanges angling downward and toward one another; and means for connecting the substrate base with the riser including a T-nut having a flange and a corresponding screw, said T-nut slideably and non-rotatably supported within the T-shaped slot and said screw rotatably and slideably supported by the pair of flanges and wherein the riser is secured to the substrate base by inserting the screw into the T-nut.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made to the drawings which illustrate the best known mode of carrying out the invention and wherein the same reference numerals indicate the same or similar parts throughout the several views.

FIG. 1 is a perspective view of a doorway incorporating a sill assembly according to an embodiment of the present invention.

FIG. 2 is a cross-sectional view of the sill assembly of FIG. 1 taken along line Z-Z.

FIG. 3 is a partial section perspective view of an embodiment of a sill assembly illustrating a T-nut/screw fastening assembly.

FIG. 4 is a cutaway view of an embodiment of a sill assembly

FIG. 5 is a perspective view of an embodiment of a sill assembly for a doorway including an active door and sidelight or non-active door.

### DETAILED DESCRIPTION

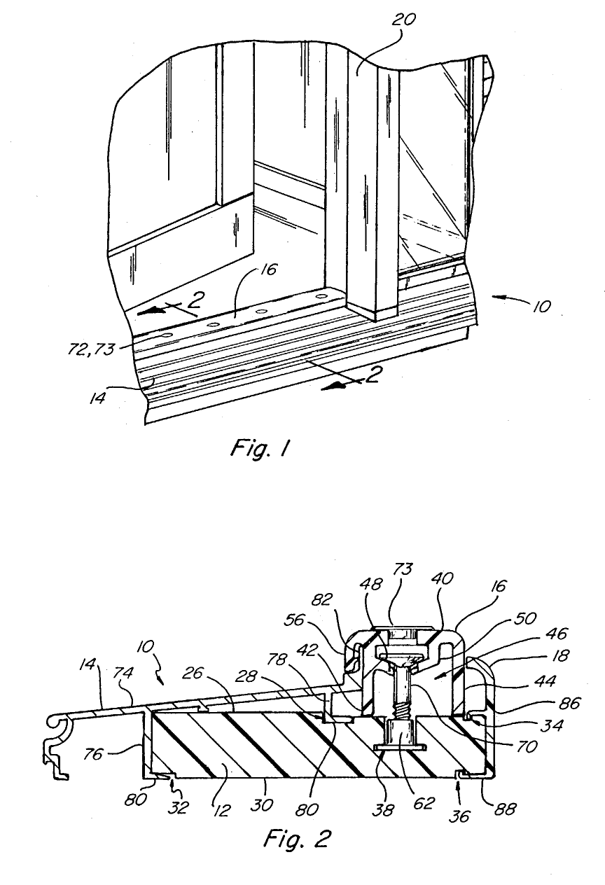

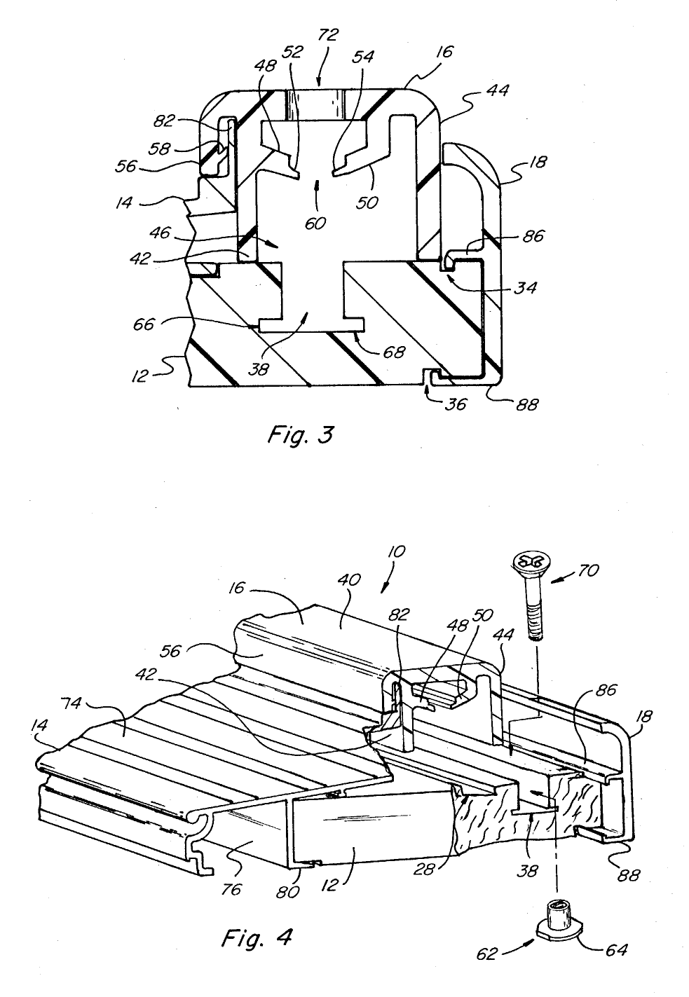

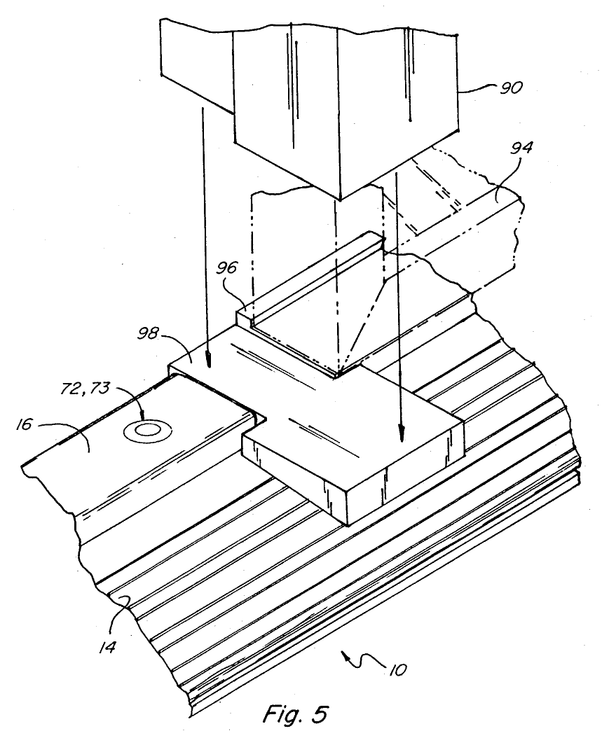

FIGS. 1-4 illustrates a sill assembly shown generally at 10 including a substrate 12, a sill 14, a riser 16, and a trim piece 18. FIG. 1 illustrates a sill assembly 10 of this design installed in a door frame 20 between the door jambs.

The substrate 12 shown in FIGS. 1-4 is generally rectangular in shape with a number of grooves formed therein. In the embodiment shown, the top surface 26 of the substrate 12 includes a first sill groove 28. The bottom surface 30 of the substrate 12 includes a second sill groove 32. The first and second sill grooves 28, 32 aid in securing the sill 14 to the substrate 12. The substrate 12 is also provided with a first trim groove 34 in the top surface 26 and a second trim groove 36 in the bottom surface 30. These grooves aid in securing the trim piece 18 to the substrate 12. The top surface 26 of the substrate 12 also includes a T-shaped slot 38 that extends along the entire length of the substrate 12 and opens to the top surface 26. In a preferred embodiment, the substrate 12 is manufactured from a composite material that is processed to form the desired cross-section for the substrate.

The riser 16 includes a top surface 40 and first 42 and second 44 legs extending generally downward from the top surface. The top surface 40, first leg 42 and second leg 44 define an interior 46 of the riser 16. A first flange 48 and a second flange 50 are located within the interior 46 of the riser 16. In the embodiment shown, the first flange 48 emanates from the first leg 42 and the second flange 50 is supported by the top surface 40 of the riser. However, the flanges 48, 50 may be supported by the first and second legs, respectively, the top surface 40, or the top surface 40 and second leg 44, respectively. Advantageously, the first and second flanges 48, 50 angle downward and toward one another forming a generally V-shaped structure with an opening 60 at the vertex of the flanges. An extension 52, 54 is located at the end of each flange 48, 50. Preferably, the extensions 52, 54 are made of a softer durometer material than the rest of the riser 16, such as a plastic material. The riser 16 itself is preferably made of an extruded plastic material, although a number of extrudable materials are suitable. In a preferred embodiment, the extensions 52, 54 are co-extruded with the rest of the riser. The riser 16 also includes a sealing leg 56 extending out and downward from the top surface 40 of the riser 16. The sealing leg includes a sealing extension 58 that extends into the space between the sealing leg 56 and first leg 42. The sealing leg 56 and extension 58 engage the sill in manner described below in order to form a weather seal for the sill assembly.

During installation, the riser 16 is positioned on top of the substrate 12 with the opening 60 at the vertex of the flanges located generally above the T-shaped slot 38. A T-nut 62 having a flange 64 is inserted into the T-shaped slot 38 with first and second lateral extensions 66, 68 of the slot accommodating the flange 64. A corresponding screw 70 is inserted between the flanges 48, 50, with the flanges supporting the head of the screw 70 and the threaded portion of the screw extending through the opening 60 between the flanges. The extensions 52, 54 of the flanges engage the screw 70 to restrict both vertical and lateral movement of the screw, thereby eliminating any need for a push nut or similar structure to secure the screw. This, in turn, eliminates the need to use special fasteners, for example, screws having shoulders designed to accommodate push nuts. Any standard screw of suitable length may be used instead. In order to secure the riser 16 to the substrate 12, the screw 70 is inserted into the T-nut 62, and the screw 70 is tightened. The height of the riser 16 relative to the substrate 12 is adjustable by varying the extent to which the screw 70 is tightened into the T-nut 62. The riser 16 is preferably provided with a number of access holes 72 in the top surface 40 through which a screwdriver may be inserted in order to tighten the screw 70. Caps 73 are provided to cover the access holes 72 and present a finished appearance. At least two T-nuts with corresponding screws are generally necessary to securely fasten the riser to the substrate in a level manner. In a preferred embodiment, a T-nut with a corresponding screw is positioned approximately every ten inches along the sill assembly.

The slot 38 allows the T-nut 62 to be positioned anywhere along the length of the substrate 12. Similarly, the flanges 48, 50 permit lateral movement of the screw 70 along the length of the riser 16, although such movement does require some force due to the restriction of the extensions 52, 54, to allow the screw 70 to be positioned anywhere along the length of the riser. This feature allows the position of the T-nut and screw fastening assemblies to be varied along the length of the riser/substrate subassembly. This arrangement enhances the modularity of the sill assembly by permitting greater interchangeability of parts.

The sill 14 features a sloping top surface 74 having a number of ridges designed to enhance traction. On the underside of the sill 14 are located a front support 76 and a rear support 78. Each of the supports 76, 78 is provided with a lateral extension 80, 82. The front extension 80 is arranged to engage the second sill groove 32 in the substrate, while the rear extension 82 engages the first sill groove 28 to connect the sill 14 with the substrate 12. The sill 14 also includes a sealing lip 84 which engages with the sealing leg 56 and extension 58 to form a weather seal. The remaining features of the sill 14 are generally known in the art and, therefore, will not be described in more detail.

The trim piece 18 is preferably made from a material similar to that used for the riser 16. Furthermore, both the riser 16 and trim piece 18 are provided with an identical finish in order to provide the sill assembly with aesthetically pleasing visible surfaces. The trim piece includes first and second connecting extensions 86, 88 which engage with the first and second trim grooves 34, 36 in the substrate, respectively, to secure the trim piece to the substrate.

It is envisioned that each of the primary pieces of the sill assembly, the substrate, riser, sill and trim piece, will form a modular system in which these pieces may be interchanged. The easy adaptability of the system will decrease manufacturing costs and the amount of inventory a manufacturer must carry. Furthermore, because the screws used in the assemblies are standard, the amount of custom hardware necessary to assemble the product is minimized.

FIG. 5 illustrates an embodiment of the sill assembly in a doorway having a door and a sidelight. The sill assembly 10 lies in a door frame (not shown in detail). A mullion 90 is positioned in the door frame between a door (not shown) and a sidelight 94. A riser 16 attached to a substrate (not shown), as described above, extends under the door between one outer jamb and the mullion 90. Between the mullion 90 and the other outer jamb, a sidelight adapter 96, or fixed sill, is attached to the substrate to provide a level surface for installing the sidelight 94. Like the other pieces of the system, the sidelight adapter 96 is intended to be extruded in a few standard lengths and cut to length at the installation site. A mullion adapter 98 is attached to the substrate between the riser 16 and the sidelight adapter 96 and provides a level surface for mounting the mullion 90. This eliminates the need to cut the profile of the sill assembly into the mullion 90.

The above components are also suitable for use in patio or french doors. These doorways usually include dual opposing doors separated by an astragal. One of the opposing doors is generally kept fixed most of the time and is referred to as the non-active door. The astragal may be attached to one of the opposing doors but is usually attached to the non-active door. In this arrangement, a fixed sill can be attached to the substrate underneath the non-active door and the astragal, while a riser 16 can be positioned underneath the operating door. The modular design of the sill assembly allows the riser 16 and fixed sill to be easily configured whether the non-active door is on the right or left side of the doorway.

Other objects, features and advantages of the present invention will be apparent to those skilled in the art. While preferred embodiments of the present invention have been illustrated and described, this has been by way of illustration and the invention should not be limited except as required by the scope of the appended claims and their equivalents.

What is claimed is:

1. An adjustable sill assembly, including:
an elongated substrate base defining a T-shaped slot extending along the length of the substrate base and open to a top surface of the substrate base;
a sill plate connected with the substrate base;
a riser having a top and two downwardly-extending legs defining an interior of the riser, said interior of the riser having a first flange and a second flange angling downward and toward one another; and
means for connecting the substrate base with the riser including a sliding T-nut having a flange and a corresponding screw, said T-nut slideably and non-rotatably supported within the T-shaped slot and said screw rotatably and slideably supported by the first and second flanges and wherein the riser is secured to the substrate base by inserting the screw into the T-nut.

2. An adjustable sill assembly as set forth in claim 1, wherein the riser is composed of a plastic material and further comprising:
an extension connected to each of the first and second flanges, said extension composed of a plastic material having a softer durometer than the plastic material of the riser.

3. An adjustable sill assembly as set forth in claim 1, further including a trim piece having first and second connecting extensions and wherein the substrate base defines a first trim groove in the top surface of the substrate base and a second trim groove in a bottom surface of the substrate base, said first and second connecting extensions engaging with the first and second trim grooves to attach the trim piece to the substrate base.

4. An adjustable sill assembly as set forth in claim 1, wherein the elongated substrate base is composed of a molded composite material.

5. An adjustable sill assembly, including:
an elongated substrate base defining a T-shaped slot extending along the length of the substrate base and open to a top surface of the substrate base;
a riser;
means for connecting the substrate base with the riser including a T-nut and a corresponding screw, said T-nut slideably supported within the T-shaped slot and said screw supported by the riser and wherein the riser is secured to the substrate base by inserting the screw into the T-nut.

6. An adjustable sill assembly as set forth in claim 5, wherein the riser includes a top and two downwardly-extending legs defining an interior of the riser, said interior of the riser having a first flange and a second flange angling downward and toward one another and wherein the screw is slideably and rotatably supported by the first and second flanges.

7. An adjustable sill assembly as set forth in claim 5, wherein the T-nut includes a base flange having a generally rectangular shape with two parallel straight edges and two rounded edges.

8. An adjustable sill assembly as set forth in claim 7, wherein the width of the base flange of the T-nut is less than the width of the T-shaped slot while the length of the base flange is greater than the width of the T-shaped slot.

9. An adjustable sill assembly as set forth in claim 5, wherein the riser is composed of a plastic material and further including an extension connected to each of the first and second flanges, said extension composed of a plastic material having a softer durometer than the plastic material of the riser.

10. An adjustable sill assembly as set forth in claim 5, wherein the substrate base is composed of a molded composite material.

11. A method of preparing a sill assembly for installation into a door frame having first and second door jambs, including the steps of:
selecting a substrate base composed of molded composite and defining a T-shaped slot extending along the length of the substrate base and open to a top surface of the substrate base;
selecting a riser having a top and two downwardly-extending legs defining an interior of the riser, said interior of the riser having a pair of flanges angling downward and toward one another;
selecting a sill member and a trim piece;
attaching said sill member and trim piece to the substrate base;
sliding a plurality of corresponding screws between the flanges of the riser;
sliding a plurality of corresponding T-nuts into the T-shaped slot of the substrate base; and
inserting each screw into the corresponding T-nut, thereby connecting the riser to the substrate base.
